(19) United States
(12) Patent Application Publication
(10) Pub. No.: US 2024/0306725 A1
(43) Pub. Date: Sep. 19, 2024

(54) Electronic Device and Electronic Cigarette

(71) Applicant: Shenzhen Yishi Erniao Technology Co., Ltd, Shenzhen (CN)

(72) Inventor: Jiugui TIAN, Shenzhen (CN)

(73) Assignee: Shenzhen Yishi Erniao Technology Co., Ltd, Shenzhen (CN)

(21) Appl. No.: 18/420,799

(22) Filed: Jan. 24, 2024

(51) Int. Cl. A24F 40/53; A24F 40/60; A24F 40/90; H02J 7/00

(52) U.S. Cl. CPC A24F 40/53; A24F 40/60; A24F 40/90; H02J 7/00304; H02J 7/0034; H02J 7/0047; H02J 7/00711; H02J 2207/50

(57) ABSTRACT

An electronic device and an electronic cigarette comprise an MCU, a charging interface coupled with the MCU, and further comprise a fast charge-discharge module, wherein one end of the fast charge-discharge module is electrically connected with a charging interface, and the other end of the fast charge-discharge module is electrically connected with the MCU; a backflow prevention module coupled between the charging interface and the rapid charge-discharge module and electrically connected with the MCU; an electric heating module electrically connected with the rapid charge-discharge module; and a sensor electrically connected with the MCU.

### TECHNICAL FIELD

The present invention relates to the field of electronic cigarettes, in particular to an electronic device and an electronic cigarette.

### BACKGROUND

Electronic cigarettes do not produce carbon monoxide or other micro-particles when used, and will not cause problems such as yellow teeth and bad breath when used for a long time, and they are more convenient to carry without open fire. At present, electronic cigarettes have become a new choice for many people. Among them, disposable electronic cigarettes are favored because they do not need a charger, do not need to replace cigarettes, have more cigarette liquid and taste better, and their sales are also rising.

US patent document US20190373952A1 discloses a portable vaporizer device with an integrated multi-port charging system, in which a charging system supporting USB OTG charging is built in, which can maximize portability without a separate external charging unit, and can charge from many portable electronic devices, and it is internally powered by a 3.7 V Li-Ion/Li-Poly battery. However, there are still loopholes in the above solution.

In the prior art, disposable electronic cigarettes mostly use high-rate li-polymer to supply power for equipment. Due to the control of inflammable and explosive articles by international/domestic air freight logistics, such disposable electronic cigarettes are difficult to transport, and generally can only be built and sold in target countries. At the same time, it is likely to cause safety accidents in the process of production and transportation, such as: lithium batteries are likely to be squeezed or collided to produce explosions, or workers' misoperation will short-circuit the batteries and cause fires.

In addition, after the smoke of disposable electronic cigarettes in the prior art absorbs light, the rechargeable lithium batteries in it will generally be discarded together, which causes a very serious waste of resources and serious pollution to the environment. Therefore, British and European countries require electronic cigarette enterprises to recycle the lithium batteries in electronic cigarettes, and this policy has brought great economic pressure to related enterprises, because the cost of recycling lithium batteries is quite high, which is generally hundreds of millions of dollars a year.

### SUMMARY

In order to solve the problems existing in the prior art, the present invention provides an electronic device and an electronic cigarette. In this solution, a supercapacitor is introduced to replace the high-rate li-polymer battery used in the disposable electronic cigarette in the prior art, and electricity is obtained through the OTG function; in use, a MCU always monitors the voltage across the supercapacitor and adjusts the duty cycle of the input current, so that the solution can adapt to different currents.

In order to achieve the above object, the technical solution of the present invention is as follows:

An electronic device includes an MCU and a charging interface coupled with the MCU; the electronic device further comprises a fast charge-discharge module; one end of the fast charge-discharge module is electrically connected with the charging interface, and the other end is electrically connected with the MCU; and
a backflow prevention module coupled between the charging interface and the rapid charge-discharge module and electrically connected with the MCU; and
an electric heating module electrically connected with the rapid charge-discharge module; and
a sensor electrically connected with the MCU.

According to the solution disclosed by the present invention, an electronic device using a fast charge-discharge module instead of a traditional lithium battery is provided, and the problem that current is easily caused to flow backwards when the fast charge-discharge module is discharged is solved by arranging an backflow prevention module.

The present invention further provides another solution.

An electronic cigarette includes a cigarette rod with a cigarette holder at one end, an MCU arranged inside the cigarette rod, and a charging interface arranged at the other end of the cigarette rod and coupled with the MCU, wherein the electronic cigarette further comprises a fast charge-discharge module, one end of which is electrically connected with the charging interface and the other end of which is electrically connected with the MCU; and
a backflow prevention module coupled between the charging interface and the rapid charge-discharge module and electrically connected with the MCU; and
an electric heating module electrically connected with the rapid charge-discharge module; and
a sensor electrically connected with the MCU.

The present invention further provides another solution.

A method for an electronic device to automatically adapt to different currents includes the following steps:
step 1, connecting a mobile device supporting an OTG function with the electronic device and supplying power to the electronic device through the OTG function;
step 2, determining, by a voltage detection module and a backflow prevention module, whether the OTG function of the mobile device is normally turned on, and proceeding to step 3 if the OTG function is normally turned on;
Step 3, detecting and recording, by a MCU inside the electronic device, a current intensity during an energy storage process of a fast charge-discharge module through a charging detection module, and determining whether the fast charge-discharge module has finished energy storage; At the same time, detecting, by the MCU, an OTG overcurrent protection threshold of the mobile device in real time, and manipulating a PWM module to adjust a current duty ratio;
step 4, if the mobile device triggers OTG overcurrent protection and stops supplying power to the electronic device, powering off the voltage detection module and the charging detection module; if the mobile device does not trigger OTG overcurrent protection, skipping this step;
step 5, releasing electric energy by the energy storage module to supply power to the MCU for a short time, and the MCU sending a reset signal to the charging interface to enable the mobile device to restore power supply; if the mobile device does not trigger OTG overcurrent protection, skipping this step; and
step 6, repeating steps 2 and 3.

According to the solution disclosed by the present invention, the electronic device tries to trigger OTG protection by the mobile device, and judges the maximum current output by the mobile device OTG through MCU calculation, so that the electronic device can automatically adapt to the OTG currents of different mobile devices.

Compared with the prior art, the electronic cigarette provided by the solution has the advantages that power is supplied by the OTG technology, so that power can be conveniently taken from the mobile phone with the OTG function, and the electronic cigarette is free from the bondage of the charger, and is more convenient to carry and use; it automatically adapts to the currents output by different mobile phones, which is more convenient to use; the high-rate li-polymer battery is replaced with a supercapacitor, which is convenient for transportation and storage, and is safer and more environmentally friendly.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic block diagram of an electronic device of the present invention;

FIG. 2 is a schematic diagram of an electronic cigarette according to the present invention;

FIG. 3 is a circuit diagram of the electronic device of the present invention:

FIG. 4 is a circuit diagram of another embodiment of the electronic device of the present invention;

FIG. 5 is a circuit diagram of another embodiment of the electronic device of the present invention.

in the figures: Cigarette rod (10); Cigarette holder (11); MCU (101); Charging interface (102); Fast charge-discharge module (103); Backflow prevention module (104); Electric heating module (105); Sensor (106); PWM module (107); Step-down module (108); Charging detection module (109); Energy storage module (110); Voltage detection module (111); Indicator lamp module (112).

### DESCRIPTION OF EMBODIMENTS

In the following, the technical solution in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

The present invention will be further described in detail with reference to the attached drawings and specific embodiments.

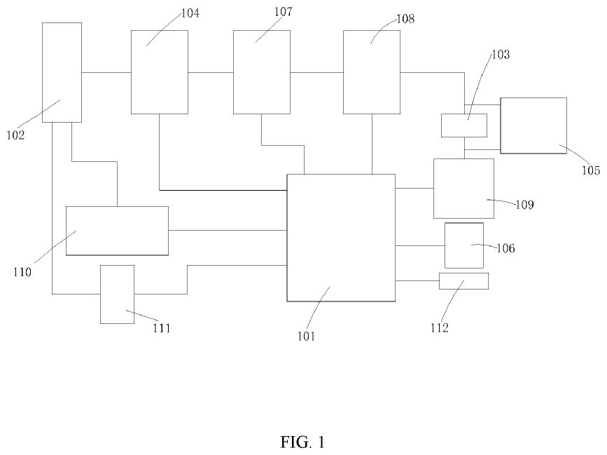

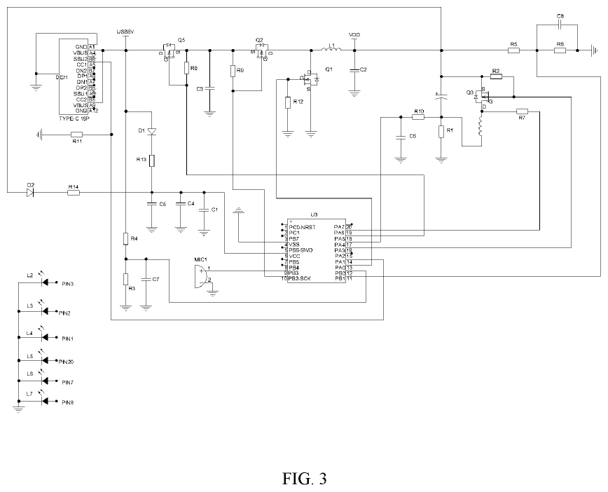

An electronic device as shown in FIGS. 1 and 3 includes an MCU and a charging interface coupled to the MCU. The charging interface supports the OTG function and can be of Micro-USB, Type-C, Lighting and other types. In this embodiment, the Type-C interface is used. It further includes a fast charge-discharge module, one end of which is electrically connected with the charging interface and the other end of which is electrically connected with the MCU. In this embodiment, the fast charge-discharge module uses a supercapacitor with specifications of 10 F and 3.2V; a backflow prevention module coupled between the charging interface and the rapid charge-discharge module and electrically connected with the MCU; an electric heating module electrically connected with the rapid charge-discharge module; a sensor electrically connected with the MCU.

According to the solution disclosed by the present invention, an electronic device using a fast charge-discharge module instead of a traditional lithium battery is provided, so that the product has higher safety and can reduce the production cost; at the same time, a backflow prevention module is additionally arranged to solve the current backflow problem that may be encountered when the fast charge-discharge module discharges.

In this embodiment, the device also includes a PWM module, which is coupled between the backflow prevention module and the fast charge-discharge module, and is electrically connected with the MCU for adjusting the OTG power supply current from smart phones and other devices in real time; it also includes a step-down module, which is coupled between the backflow prevention module and the fast charge-discharge module, electrically connected to the MCU and connected in series with the PWM module; it also includes a charging detection module that is coupled between the MCU and the fast charge-discharge module, and detects the charging current of the fast charge-discharge module and feeds it back to the MCU, so that the MCU can judge the charging state of the fast charge-discharge module, thereby adjusting the supplied voltage.

In this embodiment, the device further includes an energy storage module, which uses a capacitor to store electric energy. After the mobile device triggers overvoltage protection due to an excessive OTG current, the energy storage module can provide electric energy for the MCU within 30-50 ms, so that the MCU can send a reset signal to the charging interface, so that the charging interface can restore OTG power supply; at the same time, the energy storage module is coupled between the MCU and the charging interface, and has a structure to prevent the released current from flowing back to the charging interface, so as to prevent the backward current from charging the mobile device.

In this embodiment, the device further includes a voltage detection module, which is coupled between the MCU and the charging interface. The voltage detection module can judge whether the OTG power supply is normal when the device is connected to the mobile device, and can also judge whether the fast charge-discharge module discharges backward.

In this embodiment, an indicator lamp module is also included, and the indicator lamp module is electrically connected with the MCU for indicating the charging state and working state of the device.

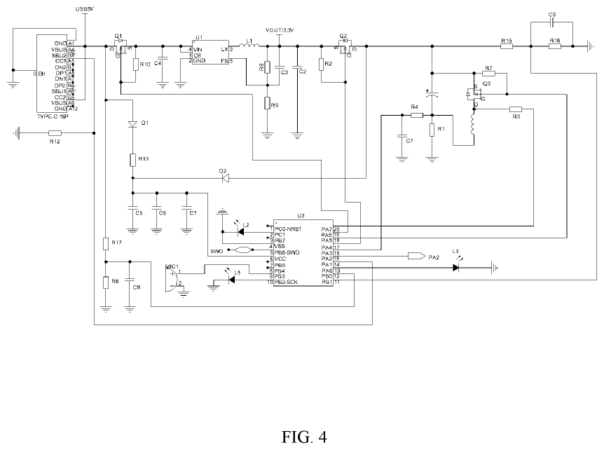

In another embodiment, as shown in FIG. 4, an integrated chip can also be used to replace the original step-down module circuit; at the same time, the setting positions of the step-down module and PWM module can be adjusted.

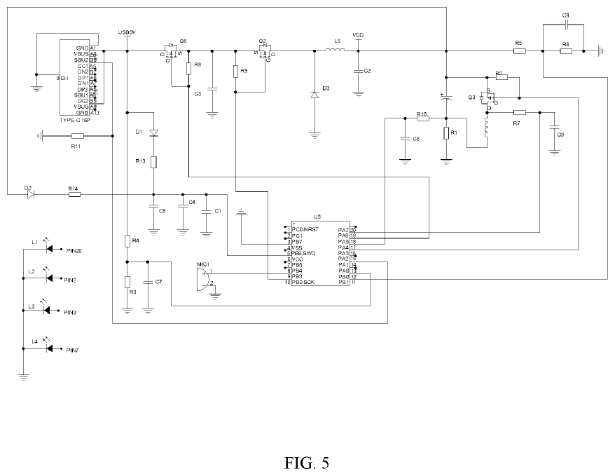

In another embodiment, as shown in FIG. 5, a step-down circuit including a freewheel diode can also be used to replace the original step-down module circuit, and the original synchronous step-down function can be changed into asynchronous step-down to achieve the original effect.

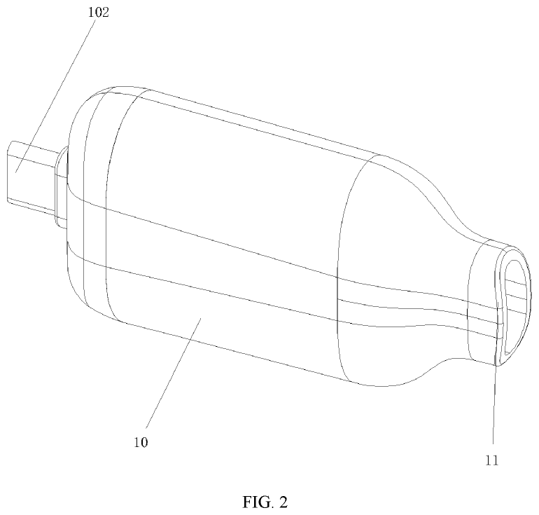

The present invention further provides an electronic cigarette, as shown in FIG. 2, which includes a cigarette rod, one end of which is provided with a cigarette holder, and the electronic device in the above solution is arranged inside the cigarette rod; wherein, the charging interface is arranged at the other end of the cigarette rod.

The present invention further provides a method for automatically adapting an electronic device to different currents, which includes the following steps:
step 1, connecting a mobile device supporting an OTG function with the electronic device and supplying power to said electronic device through the OTG function;
step 2, determining, by a voltage detection module and a backflow prevention module, whether the OTG function of said mobile device is normally turned on, and proceeding to step 3 if said OTG function is normally turned on;
step 3, detecting and recording, by a MCU inside said electronic device, a current intensity during an energy storage process of a fast charge-discharge module through a charging detection module, and determining whether said fast charge-discharge module has finished energy storage; At said same time, detecting, by said MCU, an OTG overcurrent protection threshold of said mobile device in real time, and manipulating a PWM module to adjust a current duty ratio;
step 4, if said mobile device triggers OTG overcurrent protection and stops supplying power to said electronic device, powering off said voltage detection module and said charging detection module; if said mobile device does not trigger OTG overcurrent protection, skipping this step;
step 5, releasing electric energy by said energy storage module to supply power to said MCU for a short time, and said MCU sending a reset signal to said charging interface to enable said mobile device to restore power supply; if said mobile device does not trigger OTG overcurrent protection, skipping this step; and
step 6, repeating steps 2 and 3.

In this embodiment, the method further includes the following steps: the step-down module reducing the voltage provided by the mobile device to a range suitable for charging by the fast charge-discharge module, thereby providing a charging current to the fast charge-discharge module; this step can be located before or after the step 3.

In this embodiment, the fast charge-discharge module includes a supercapacitor, and the specifications of the supercapacitor are 10F, 3.2V; the backflow prevention module prevents the current released by the fast charge-discharge module from flowing back to the charging interface, so as to prevent the charging interface from being wrongly identified as charging and causing the OTG function to fail; the energy storage module uses a capacitor to store electric energy. When the mobile device triggers overcurrent protection, the energy storage module releases electric energy to power the MCU for 30-50 ms, and the MCU sends a reset signal to the charging interface; at the same time, the energy storage module has a structure to prevent the released electric energy from flowing back to the charging interface to avoid charging of the charging interface.

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. An electronic device comprising an MCU and a charging interface coupled with said MCU, wherein said electronic device further comprises a fast charge-discharge module; one end of the fast charge-discharge module is electrically connected with said charging interface, and the other end is electrically connected with said MCU; and
a backflow prevention module coupled between said charging interface and said rapid charge-discharge module and electrically connected with said MCU; and
an electric heating module electrically connected with said rapid charge-discharge module; and
a sensor electronically connected with said MCU.

2. The electronic device according to claim 1, wherein said fast charge-discharge module comprises a supercapacitor; said charging interface supports OTG technology, including Micro-USB, Type-C, Lighting and other types.

3. The electronic device according to claim 1, further comprising a PWM module, which is coupled between said backflow prevention module and said rapid charge-discharge module and electrically connected to said MCU.

4. The electronic device according to claim 3, further comprising a step-down module, which is coupled between said backflow prevention module and said rapid charge-discharge module, electrically connected to said MCU and connected in series with said PWM module.

5. The electronic device according to claim 1, further comprising a charging detection module coupled between said MCU and said fast charge-discharge module.

6. The electronic device according to claim 1, further comprising an energy storage module coupled between said MCU and said charging interface, and having a structure for preventing discharged current from flowing back to said charging interface.

7. The electronic device according to claim 1, further comprising a voltage detection module coupled between said MCU and said charging interface.

8. The electronic device according to claim 1, further comprising an indicator lamp module electronically connected with said MCU.

9. An electronic cigarette, comprising a cigarette rod with a cigarette holder at one end, an MCU arranged inside said cigarette rod, and a charging interface arranged at the other end of said cigarette rod and coupled with said MCU, wherein said electronic cigarette further comprises a fast charge-discharge module, one end of which is electrically connected with said charging interface and the other end of which is electrically connected with said MCU; and
a backflow prevention module coupled between said charging interface and said rapid charge-discharge module and electrically connected with said MCU; and
an electric heating module electrically connected with said rapid charge-discharge module; and
a sensor electrically connected with said MCU.

10. The electronic cigarette according to claim 9, wherein said rapid charge-discharge module comprises a supercapacitor; said charging interface supports OTG technology, including Micro-USB, Type-C, Lighting and other types.

11. The electronic cigarette according to claim 9, further comprising a PWM module, which is coupled between said backflow prevention module and said rapid charge-discharge module and is electrically connected with said MCU.

12. The electronic cigarette according to claim 11, further comprising a step-down module, which is coupled between said backflow prevention module and said rapid charge-discharge module, electrically connected to said MCU and connected in series with said PWM module.

13. The electronic cigarette according to claim 9, further comprising a charging detection module coupled between said MCU and said rapid charge-discharge module.

14. The electronic cigarette according to claim 9, further comprising an energy storage module, which is coupled between said MCU and said charging interface and has a structure for preventing discharged current from flowing back to said charging interface.

15. The electronic cigarette according to claim 9, further comprising a voltage detection module coupled between said MCU and said charging interface.

16. The electronic cigarette according to claim 9, further comprising an indicator lamp module electrically connected with said MCU.

17. A method for an electronic device to automatically adapt to different currents, comprising the following steps:
step 1, connecting a mobile device supporting an OTG function with the electronic device and supplying power to said electronic device through the OTG function;
step 2, determining, by a voltage detection module and a backflow prevention module, whether the OTG function of said mobile device is normally turned on, and proceeding to step 3 if said OTG function is normally turned on;
step 3, detecting and recording, by a MCU inside said electronic device, a current intensity during an energy storage process of a fast charge-discharge module through a charging detection module, and determining whether said fast charge-discharge module has finished energy storage; At said same time, detecting, by said MCU, an OTG overcurrent protection threshold of said mobile device in real time, and manipulating a PWM module to adjust a current duty ratio;
step 4, if said mobile device triggers OTG overcurrent protection and stops supplying power to said electronic device, powering off said voltage detection module and said charging detection module; if said mobile device does not trigger OTG overcurrent protection, skipping this step;
step 5, releasing electric energy by said energy storage module to supply power to said MCU for a short time, and said MCU sending a reset signal to said charging interface to enable said mobile device to restore power supply; if said mobile device does not trigger OTG overcurrent protection, skipping this step; and
step 6, repeating steps 2 and 3.

18. The method for an electronic device to automatically adapt to different currents according to claim 17, further comprising the following steps:
a step-down module inside said electronic device reducing a voltage provided by said mobile device to a range suitable for charging by said fast charge-discharge module; wherein this step may be located before or after said step 3.

19. The method for an electronic device to automatically adapt to different currents according to claim 17, wherein said fast charge-discharge module comprises a supercapacitor; said backflow prevention module is used for preventing the current released by said fast charge-discharge module from flowing back to said charging interface.

20. The method for an electronic device to automatically adapt to different currents according to claim 17, wherein said energy storage module uses a capacitor to store electric energy, and said energy storage module has a structure to prevent the released electric energy from flowing back to said charging interface.
